(19) United States
(12) Patent Application Publication
(10) Pub. No.: US 2004/0024283 A1
(43) Pub. Date: Feb. 5, 2004

(54) Lead projectile mineral coating

(76) Inventor: Keith E. Forrester, Meredith, NH (US)

Correspondence Address: HAMILTON, BROOK, SMITH & REYNOLDS, P.C., 530 VIRGINIA ROAD, P.O. BOX 9133, CONCORD, MA, 01742-9133, US

(21) Appl. No.: 10/209,517

(22) Filed: Jul. 30, 2002

(51) Int. Cl. A62D 3/00

(52) U.S. Cl. 588/259

(57) ABSTRACT

The invention pertains to a method for reducing the leaching of lead from lead projectile surface. The method includes contacting the lead projectile surface with a lead stabilizing agent or a lead stabilizing agent in the presence of a lead mineral complexing agent. The lead stabilizing agents provides a means to stabilize lead on the bullet/shot surface and thus reduce lead leaching and contact to the environment. This method eliminates the need to remove or re-treat range soils and greatly reduces the environmental and health risks associated with the use of lead as projectiles in the open environment as well as at control trap ranges.

### BACKGROUND OF THE INVENTION

The leaching of lead into the environment has been a major concern of health officials and water supply professionals for many years. In addition to concern over direct leaching of lead into ground waters and surface waters, regulators and professionals have also been concerned with indirect leaching of lead from unlined landfills which generate acidic leaching conditions due to decay of organic matter and thus high levels of lead leaching potential. In response to the concern of lead leaching from both water and landfill leachate borne conditions, the USEPA under direction from Congress, prepared regulations for testing, managing, and disposing of lead bearing wastes. The regulations under the Resource Conservation and Recovery Act (RCRA) and Comprehensive Environmental Response, Compensation, and Liability Act (CERCLA—a.k.a. Superfund) are extensive, complex, and have great impact on industry and practices involving heavy metals including lead. Under RCRA, lead bearing wastes may be considered hazardous if failing the Toxicity Characteristic Leaching Procedure (TCLP) at 5.0 ppm, and thus required to be disposed of at a hazardous waste landfill or treatment, storage and disposal facility (TSDF). These options are very expensive, normally $200.00 per waste ton. Under CERCLA, regulators can control or require treatment of lead wastes at almost any level as the states have flexibility in setting cleanup standards. Consequently, producing Pb bearing waste can be very expensive. Similar regulatory and remedial cost conditions exist in Japan, Switzerland, and other countries.

To date, shooting range soils contaminated by projectile lead have mostly been subject only to CERCLA action which requires stabilization and/or disposal of the Pb projectile contaminated soils at closed range sites. The Pb projectile bearing soil produced by the firing of lead bullets and shot over land or into stop berms commonly fails TCLP criteria of 5.0 ppm and is thus a characteristic hazardous waste when disposed or managed as a solid waste, and also subject to Pb soil cleanup standards by the USEPA and state regulators which can be more stringent than TCLP criteria. The current methods used to manage these lead projectile contaminated soils are reactive, i.e., they treat the lead after the soil becomes contaminated and, consequently, after the hazard of lead exposure to the environment and biological community exists. The chemicals currently used to treat lead bearing soils include mostly phosphates, silicates, cements, and sulfides. The methods are, however, reactive in design except for U.S. Pat. No. 5,722,928 issued to Forrester which provides a method for stabilizing leachable lead by adding phosphate and complexing agents such as iron, aluminum, and chlorides to the lead bearing material or waste prior to generating waste from industrial waste production operations such as automobile shredders. Existing stabilization technology for shooting ranges also utilize methods of stabilization regardless of the range usage and thus apply readily soluble chemicals in all areas subject to lead exposure and not discriminating amongst the dosage of lead projectiles applied to any given area.

Although seemingly illogical given the state of toxicological knowledge and regulation regarding lead exposure to the environment and potential receptors such as foul, shotgun and rifle/handgun shooting ranges still operate with little or no environmental protection devices in place other than indoor trap and outdoor mechanical bullet traps at few locations. The greatest exposure to the environment and biological receptors from any open range is the use of shotguns, where the practice of firing small yet numerous lead shot pellets into the air at airborne clay targets is practiced at over 3000 sites in the US alone. The resulting shower of lead pellets covers the range site at the soil surface where the greatest degree of exposure to wildlife, storm water, surface water and biological entry exists. The more severe exposure of lead projectiles to the environment is when shotgun users fire small birdshot with relatively high surface area per pellet into the woods and open environment at birds, showering the uncontrolled open environment, streams, ponds and marshes (where bird hunting is common) with these highly toxic elemental lead pellets. Thus there exists an immediate need to provide a proactive measure that protects the environment from the exposure to the lead shot and lead projectiles while allowing shooters continuance of the target practice as well as actual field foul firing.

### SUMMARY OF THE INVENTION

The invention pertains to a method of reducing the solubility of lead on the surface of a lead projectile, comprising contacting lead projectile surface with at least one lead stabilizing agent in an amount effective in reducing the leaching of lead from lead projectile surface. In one embodiment, the lead leaching should be reduced to a level no more than 5.0 ppm lead as determined in an EPA TCLP test, performed on the projectile impact area lead contaminated soils or lead contaminated material receiving the projectile, as set forth in the Federal Register, vol. 55, no. 126, pp. 26985-26998 (Jun. 29, 1990). In another embodiment, an effective reduction in lead leaching (e.g., to about 50 ppb) can be measured using the Simulated Precipitant Leaching Procedure (SPLP) method 1310 or other water leach test.

In yet another embodiment of the invention, a phosphate (the lead stabilizing agent) and a lead mineral complexing agent are used in combination to reduce lead leaching and solubility under natural or induced lead leaching conditions. The lead mineral complexing agent can be calcium, silicates, sodium silicate, lime, magnesium oxides, calcium chloride, sodium chloride, potassium chloride, vanadium, boron, iron, aluminum, sulfates, ferric sulfate, or combinations thereof. In certain embodiments, the phosphate source may contain the lead mineral complexing agent, e.g., amber wet acid is produced in a manner such that it inherently contains the lead mineral complexing agent. Thus, the method is carried out in the presence of the lead mineral complexing agent since the phosphate source also provides the complexing agent as one product. Additional complexing agent beyond the amount provided by the phosphate source can be used.

The invention also pertains to a method of reducing bioavailability of lead by reducing Pb solubility from the surface at least one lead stabilizing agent in an amount effective in reducing the leaching of lead from lead projectile surface under natural or induced lead leaching conditions.

The invention also pertains to lead-containing projectiles having coated thereon at least one lead stabilizing agent in an amount effective in reducing the leaching of lead from lead projectile surface under natural or induced lead leaching conditions, whereby the lead and stabilizing agent form a mineral coating on the projectile in which the lead is in a form that is less soluble than its uncoated counterpart. The insoluble mineralized, coated projectiles can be produced by the method comprising coating lead-containing projectile with at least one lead stabilizing agent in an amount effective in reducing the leaching of lead from lead projectile surface under natural or induced lead leaching conditions, and allowing the coating to cure, wherein the lead and stabilizing agent form a mineral coating on the projectile in which the lead is in a form that is less soluble than its uncoated projectile counterpart.

This invention has the advantage of reducing the solubility of lead immediately upon first generation of the projectiles as a contaminant into the berm soil as well as into the environment. This method allows the soil berm and other lead projectile exposed soils/materials to remain below TCLP levels and thus exempt from RCRA hazardous waste regulation. This pre-firing stabilization method also assures control of Pb leaching and reduction of ecological and human exposure risks by creation of immediate upon contact water insoluble lead mineral coating(s). The desired mineral coatings produced would include Pb₅(P0₄)₃C1 (chloropyromorphite), calcium complexed phosphorus, Pb₃(P0₄)₂ (lead phosphate), lead silicates, corkite, plumbogummite, and other relatively insoluble lead minerals which have significantly less mobility and toxicity than the projectile lead form as elemental or lead oxides. The invention provides a means to control Pb solubility both under TCLP testing for hazardous waste classification as well as Pb bioavailability in the open environment without significantly modifying the lead projectile weight and function and providing for such Pb surface mineralizing at an affordable price.

### DETAILED DESCRIPTION OF THE INVENTION

A description of preferred embodiments of the invention follows.

This invention relates to the method of forming highly insoluble lead minerals on the surface of lead projectiles used in shotguns, handguns, rifles, and other ammunition, to reduce the leaching of lead therefrom when the projectiles are exposed to leaching conditions. The term “leaching or leachable conditions” used herein means any natural or induced condition that causes lead to solubilize and be removed from the lead-containing projectile with the mineral stabilizing agents. The insoluble lead mineral surface is formed prior to firing the projectile into the collection soils and/or open environment by contacting the projectile, prior to assembly with propellant shells or after bullet assembly. The lead-containing projectile is treated with a solution or slurry of phosphate or phosphate in combination with lead complexing agents including calcium chloride, calcium oxide, magnesium oxide, iron, aluminum, surfactants, mineral precipitant agents and combinations thereof. Formation of insoluble Pb minerals upon the surface of the lead-containing projectile will stabilize the Pb such that its leachability, under natural or induced leaching conditions, is reduced compared to its untreated form. A reduction in leaching can be assessed by any natural or induced leach test conditions such as, but not limited to TCLP (Method 1311), Simulated Precipitant Leaching Procedure (SPLP- Method 1310 which simulates rainwater leaching), Japan DI (uses acid adjusted DI water for 6 hours to simulate rainwater leaching), Swiss sequential DI (uses sequential DI water leaching to simulate rainwater), rainwater and other related leaching of lead from the surface of rifle, handgun and shotgun bullets.

The invention further pertains to lead projectiles treated according to the method. In one embodiment, the lead projectiles, in the form of pellets or shot, are coated with the stabilizing agent and optionally the lead mineral complexing agent, prior to placing the pellets or shot into the shell casing or housing. Dicalcium phosphate and/or tricalcium phosphate are the preferred phosphates as they impart a film upon the pellets or shot which functions as a proactive and reactive stabilizing seed. See Example 3. The plastic casing within the housing protects the phosphate coating on the shot until the shot is released upon firing. In another embodiment, projectiles in the form of bullets that come in contact with the gun barrel will preferably be coated with a phosphate other than dicalcium or tricalcium phosphate, preferably amber acid as the coating resulting therefrom is integral to the projectile and less prone to be removed between the breach and gun barrel exit by rifling edge contact with the projectile.

The invention further pertains to methods of reducing the bioavailablity of such projectiles upon exposure to the stomach acids of animals, humans or other biological exposures. The term “bioavailability” is intended to mean herein the form of Pb that is hazardous to humans, animals and plants, and can be assessed, for example in animals by studying metal uptake in kidneys and other organs. The method includes contacting the lead projectile surface with at least one lead stabilizing agent such that lead projectile surface has reduced Pb leaching potential prior to exposure to the environment, projectile collecting traps and/or biological community.

The term “stabilization” is herein defined as any reduction in the leachable levels of lead from the surface of projectiles used in rifle, handgun, shotgun, or other lead projectile ammunition, where the reduction is compared to an untreated projectile. The confirmation of Pb surface leaching reduction can be determined by performing a suitable leaching test on the projectile as well as physical evaluations of mineral formation under selective electron microscopy (SEM) and/or x-ray diffraction (XRD) techniques.

Projectile lead surfaces can be in elemental form and/or cationic form. The most common form of projectile lead is elemental in the form of projectile slugs or shot pellets. Soils and materials subjected to Pb projectile surface exposure can contain commonly as high as 100,000 ppm compositional lead and 1500 ppm TCLP leachable lead. Leachable lead in lead projectile exposed soils is commonly from 50 to 500 ppm TCLP, 200 ppm California Soluble Threshold Limit Concentration (STLC) and between 0.5 and 5.0 ppm total soluble and 1.0 micron suspended colloidal lead by water column and water extraction tests.

Leach test conditions, as defined herein, include the conditions to which a material or soil is subjected during dilute acetic acid leaching (TCLP), buffered citric acid leaching (STLC), distilled water, synthetic rainwater or carbonated water leaching (US SPLP, Japanese and Swiss and SW-924). Suitable acetic acid leach tests include the USEPA SW-846 Manual described Toxicity Characteristic Leaching Procedure (TCLP) and Extraction Procedure Toxicity Test (EP Tox) now used in Canada. Briefly, in a TCLP test, 100 grams of waste are tumbled with 2000 ml of dilute and buffered acetic acid for 18 hours. The extract TCLP (fluid number 1) solution is made up from 5.7 ml of glacial acetic acid and 64.3 ml of 1.0 normal sodium hydroxide up to 1000 ml dilution with reagent water. SPLC uses the ame tumbling as TCLP, but replaces acetic acid with simulated acid rain (e.g., a solution of carboxyl acid to pH 5.8 east of the Mississippi river and pH 5.9 west of the Mississippi river).

Suitable water leach tests include the Japanese leach test which tumbles 50 grams of composited soil sample in 500 ml of water for 6 hours held at pH 5.8 to 6.3, followed by centrifuge and 0.45 micron filtration prior to analyses. Another suitable distilled water CO₂ saturated method is the Swiss protocol using 100 grams of cemented waste at 1 cm³ in two (2) sequential water baths of 2000 ml. The concentration of heavy metals and salts are measured for each bath and averaged together before comparison to the Swiss criteria.

Suitable citric acid leach tests include the California Waste Extraction Test (WET), which is described in Title 22, Section 66700, “Environmental Health” of the California Health & Safety Code. Briefly, in a WET test, 50 grams of waste are tumbled in a 1000 ml tumbler with 500 grams of sodium citrate solution for a period of 48 hours. Leachable lead, contained in the waste, then complexes with citrate anions to form lead citrate. The concentration of leached lead is then analyzed by Inductively-Coupled Plasma (ICP) after filtration of a 100 ml aliquot from the tumbler through a 0.45 micron glass bead filter. A WET result of ≧5 ppm lead will result in the range soil as hazardous in California.

According to the methods of the invention, leachable lead at the surface of a lead projectile can be stabilized by contacting at least one lead stabilizing agent with the projectile surface at sufficient dosage and duration to allow for substitution and precipitation of relatively soluble lead to relatively insoluble lead minerals. The amount of stabilizing agent incorporated within and/or upon the projectile surface will be that which is effective in reducing the leaching of lead from the projectile as needed, for example to a level no more than 5.0 ppm lead, as determined in an EPA TCLP test performed on the projectile or material receiving the projectile as set forth in the Federal Register, Vol. 55, No. 126; pp. 26985-26998 (Jun. 29, 1990), or other leaching test.

Examples of suitable lead stabilizing agents include, but are not limited to, phosphate fertilizers (e.g., MAP, DAP, SSP, TSP), phosphate rock, pulverized phosphate rock, calcium orthophosphates, monocalcium phosphate, dicalcium phosphate, tricalcium phosphate, trisodium phosphates, dolomitic limestone, hydrated limestone, calcium oxide (quicklime), calcium carbonates, magnesium oxides, silicates, sodium metasilicates, potassium silicates, natural phosphates and lead mineralizing agents and combinations of the above, phosphoric acids, green phosphoric acid, amber phosphoric acid, technical phosphoric acid, wet process produced phosphoric acids, phosphonates, Coproduct solution, hypophosphoric acid, metaphosphoric acid, hexametaphosphate, pyrophosphoric acid, polyphosphate, fishbone phosphate, animal bone phosphate, fishbone apatite, herring meal, bone meal, phosphorites, and combinations thereof. Salts of phosphoric acid can be used and are preferably alkali metal salts such as, but not limited to, trisodium phosphate, dicalcium phosphate, disodium hydrogen phosphate, sodium dihydrogen phosphate, tripotassium phosphate, dipotassium hydrogen phosphate, potassium dihydrogen phosphate, trilithium phosphate, dilithium hydrogen phosphate, lithium dihydrogen phosphate or mixtures thereof.

The lead stabilizing agent can be incorporated or applied onto the projectile surface by bath contact, spray, or other surface application means. It also remains possible that the projectile Pb may be modified during formation of the lead by applying stabilizing agent(s) to the lead melting and projectile production process, although such a process appears at this time to be more burdensome and costly than a simpler post-projectile production formation of a stabilized lead surface. Given that the lead surface is the primary exposure area to the environment and that the mineral surface will likely reduce or significantly retard lead diffusion from the non-stabilized lead core, the stabilization of the surface alone is offered as the most cost effective control of lead contamination. The invention however comtemplates use of the method of the invention in the “field” by the end user. A composition comprising the lead stabilizing agent and optionally the lead mineral complexing agent can be conveniently packaged in the form of a spray or wipes for application to older lead projectiles not stabilized during projectile and shell production.

In one embodiment of the invention, the projectile surface is contacted with a wet stabilizing agent mixture of hexametaphosphate and 32% calcium chloride solution in a simple bath reactor for 24 hours and thereafter allowed to drip dry while amorphous crystals continue to form for an additional 48 hours prior to projectile rinsing and drying, preferably at ambient temperature. The option to utilize various stabilizing agents, bath durations and complexing agents provides the production engineer flexibility in stabilizing agent recipe selection, with a preferred choice responding to the site and use criteria such as TCLP, DI or other biological based toxicity criteria.

The use of engineered phosphates such as wet process amber phosphoric acid, green phosphoric acid, aluminum finishing Coproduct blends of phosphoric acid and sulfuric acid, technical grade phosphoric acid, trisodium phosphate, tetrapotassium polyphosphate, monocalcium phosphate, monoammonia phosphate (MAP), diammonium phosphate (DAP), single superphosphate (SSP), superphosphate, triple superphosphate (TSP), hexametaphosphate (HMP) and combinations thereof would, as an example, provide various amount of water soluble phosphate contact with projectiles surface. The term “wet process amber phosphoric acid” refers to phosphoric acid formed by acidolation of phosphate rock ore with sulfuric acid. The term “green phosphoric acid” refers to phosphoric acid formed by calcined ore acidolated with sulfuric acid. The term “coproduct and coproduct blends” refers to a by-product from the finishing of aluminum comprising phosphoric acid and sulfuric acid and optionally comprising aluminum and other metals (such as iron).

In certain cases such as use of amber and green acid, such acids comprise sulfuric acid, vanadium, iron, aluminum and other complexing agents which could provide for a single-step formation of complex minerals on the lead surface. The phosphoric acids, coproducts, HMP, MAP, DAP, SSP, trisodium phosphate, tetrapotassium polyphosphate, monocalcium phosphate and TSP size, dose rate, mineral formation contact duration, application, and phosphate stabilizer contact means, could be engineered for each type of projectile and contact method employed. When lead comes into contact with the stabilizing agent, low water soluble compound(s) begin to form, typically a mineral phosphate or precipitate formed through substitution or surface bonding, which is less soluble than the lead originally in the projectile. For example, the mineral apatite lead phosphate Ca₄(Pb)(P0₄)₃ OH, lead phosphate Pb₃(P0₄)₂, lead silicate Pb₂(Si0₃), lead sulfide PbS, chloropyromorphite Pb₅(PO₄)Cl, corkite and plumbogummite can be formed by adding respective precipitating agents with complexing agents to the projectile surface at standard temperature and pressure.

It also remains possible that modifications to reactor temperature and pressure (preferably under standard temperature and pressure conditions) may accelerate or assist formation of lead minerals, although such methods are not considered optimal for this application given the need to limit cost and provide for optional field based lead stabilizing operations that would be complicated by the need for pressure and temperature control devices and vessels.

In another method, the lead projectiles are contacted with at least one phosphate in the presence of a lead mineral complexing agent selected to generate specific mineral on the projectile surface. The lead mineral complexing agent can include iron, aluminum, calcium, chlorides (e.g., sodium chloride, potassium chloride, calcium chloride), silicates (e.g., sodium silicate), sulfates (e.g., ferric sulfate), vanadium, boron, lime, magnesium oxide, surfactants and various other agents which provide for or assist in formation of phosphate minerals such as chloropyromorphite and other lead minerals. Use of phosphates in the presence of complex agents for mineral formations of lead bearing wastes is taught by U.S. Pat. No. 5,722,928 issued to Forrester, the entire teachings are incorporated herein by reference.

The amounts of lead stabilizing agent used, according to the method of invention, depend on various factors including projectile character, desired lead solubility reduction potential, desired lead mineral toxicity, and desired lead mineral formation relating to toxicological and site environmental control objectives. It has been found that an amount of certain stabilizing agents such as amber wet process phosphoric acid and calcium chloride solution, equivalent to between about 0.1% and about 2.0% by weight of projectile pellet or slug is sufficient for initial TCLP stabilization. However, the foregoing is not intended to preclude yet higher or lower usage of stabilizing agent or combinations if needed since it has been demonstrated that amounts greater than 0.5% by weight also work, but are more costly. Given the relatively smooth and non-porous surface character of lead projectiles and the atomic density of elemental lead, it is unlikely that larger amounts of stabilizers would bond, combine, precipitate or otherwise attach to the surface of the lead projectile.

Using the methods of the invention, it was discovered that insoluble mineral formation can be enhanced by one or a combination of duration in the coating bath and/or curing. The purpose of curing the projectile or shells is to allow for mineral crystals to form; more crystal growth over time. The optimal minimal duration for the projectile to reside in the coating bath is approximately 24 hours but other coating times can be used. Once the projectile is coated, it may be desirable to let it cure prior to use. The optimal duration for curing is at least 48 hours but shorter or longer cure times are contemplated. It should be noted that no curing is required to provide lead control. In view of this finding, the invention further pertains to methods of producing a lead-containing projectile having a mineral coating thereon, comprising coating lead-containing projectile with at least one lead stabilizing agent in an amount effective in reducing the leaching of lead from lead projectile surface under natural or induced lead leaching conditions, allowing the coating to cure, wherein the lead and stabilizing agent form a mineral coating on the projectile in which the lead is in a form that is less soluble than an uncoated projectile. The curing can occur during ammunition shelf storage.

The examples below are merely illustrative of this invention and are not intended to limit the invention in any way.

### EXAMPLE 1

In this example, shot projectiles were stabilized with varying amounts of stabilizing agents in aqueous solutions, including amber phosphoric acid (WAA), green acid (WAG), technical grade acid (WAT), coproduct solution (WCP), 33% hexametaphosphate solution (HMS), 32% calcium chloride solution (CCS), 50% surfactant solution (Dow TergitolTM) (SFS), 50% sodium silicate solution (NSS) and lime (CaO) pH adjusted (6.10) batch reactors under full contact wet bath exposure of projectiles to solutions with up to 24 hours and curing for 48 hours, under standard temperature and pressure. Both stabilized and un-stabilized projectiles were subsequently tested for TCLP and DI leachable Pb. Projectiles were extracted according to TCLP procedure set forth in Federal Register, Vol. 55, No. 126, pp. 26985-26998 (Jun. 29, 1990), which is hereby incorporated by reference and water extraction by substituting deionized water for the TCLP extraction fluid solution in the TCLP test. This test procedure is also referenced in 40 C.F.R. 260 (Appendix 2) and EPA SW 846, 3rd Edition. The retained leachate was digested prior to analysis by ICP. Stabilizing bath dosages were calculated by measuring projectile weight increase after final drying or each given bath recipe. It was found that projectiles had higher retention of certain bath recipes likely due to differences in surface adsorption ability and mineral formations.

TABLE 1

| | Duration | |
|---|---|---|
| Stabilizer Dose (%) | Bath/Curing (hrs) | TCLP/DI Pb (ppm) |
| 0 | 0/0 | 154/12 |
| 0.12 WAA | 1/48 | 24/ND |
| 0.11 WAA | 24/48 | 1.7/ND |
| 0.09 WAG | 24/48 | 3.2/ND |
| 0.07 WAT | 24/48 | 3.4/ND |
| 0.10 HMS | 24/48 | 4.4/ND |
| 0.11 WAA/NSS 1/1 blend | 24/48 | 0.3/ND |
| 0.14 WAA/CCS 1/1 blend | 24/48 | ND/ND |
| 0.05 WAA/SFS 1/1 blend | 24/48 | 2.2/ND |
| 0.11 WAG/CaO 1/1 blend | 24/48 (pH 6.10) | 0.40/ND |
| 0.10 WCP | 24/48 | 17/ND |
| 0.50 FBA/1 H₂O | 24/48 | ND/ND |
| 0.50 TSP/1 H₂O | 24/48 | 0.1/ND |
| 0.10 WAA | 10 seconds/0 | 32/ND |

The results in Table 1 readily established the operability of the present process to stabilize lead on the surface of lead projectiles thus reducing projectile leachability and bioavailability. Given the effectiveness of the phosphates and complexing agents in causing lead to stabilize as presented in the Table 1, it is believed that an amount of the stabilizing agents equivalent to less than 2% by weight of lead projectile should be effective to stabilize lead projectile surfaces. It is also apparent from the Table 1 results that certain stabilizing agents and complexing blends are more effective for lead surface stabilization. It also is apparent that pH increase to neutral range pH levels in the mineral bath can improve the formation of Pb minerals, as seen from standard pPb-pH diagrams on lead amphoteric and non-amphoteric solubilities.

### EXAMPLE 2

Shot projectiles were treated according to the method of Example 1 but using the formulation set forth in Table 2. Two hundred grams treated shot were fired into 5 lbs loam and leachable Pb was measured.

TABLE 2
hot Fired Samples: 200 gms into 5 lbs. Loam

| Recipe | TCLP | SPLP |
|---|---|---|
| Baseline Soil/Lead | 190 | 0.7 |
| 0.12 WAA | 17.1 | ND |
| 0.14 WAA/CCS | 4.1 | ND |
| 2.0 WAA/1 CaCl₂ | ND | ND |

### EXAMPLE 3

In this example, shot projectiles were stabilized using the method of Example 1 but using the formulations set forth in Table 3. The duration in the bath was for 24 hours. The curing time for all formulations was 24 hours.

TABLE 3

| Formulation | SPLP Pb (ppm) |
|---|---|
| 0.0% (Aged Lead Shot) | 0.54 |
| 2.0% WAA Amber Acid + 1% CaCl₂ | <0.01 |
| 2.0% DCP + 1% CaCl₂ | 0.01 |
| 2.0% TCP + 1% CaCl₂ | 0.01 |

DCP = dicalcium phosphate
TCP = tricalcium phosphate

SPLC was performed on the shot. The 2.0% DCP+1% CaCl₂ blend produced a chemical film on the shot. Shot having this coating was selected for testing in shooting range applications. The residual film will act as the proactive and reactive stabilizing seed. The shot will serve as the carrier for delivering the stabilizing agent to the range soil and surrounding environment.

While this invention has been particularly shown and described with references to preferred embodiments thereof, it will be understood by those skilled in the art that various changes in form and details may be made therein without departing from the scope of the invention encompassed by the appended claims.

What is claimed is:

1. A method of reducing the leaching of lead from the surface of a lead projectile, comprising contacting lead projectile surface with at least one lead stabilizing agent in an amount effective in reducing the leaching of lead from lead projectile surface to a level no more than 5.0 ppm lead as determined in an EPA TCLP test, said test performed on the projectile impact area lead contaminated soils or lead contaminated material receiving the projectile, as set forth in the Federal Register, vol. 55, no. 126, pp. 26985-26998 (Jun. 29, 1990).

2. The method of claim 1, wherein the lead stabilizing agent is selected from the group consisting of water soluble phosphate, phosphate in the presence of lead mineral complexing agent, phosphoric acid, wet process amber phosphoric acid, wet process green phosphoric acid, coproduct phosphoric acid solution from aluminum polishing, technical grade phosphoric acid, merchant grade phosphoric acid, hypophosphoric acid, metaphosphoric acid, pyrophosphoric acid, hexametaphosphate, polyphosphate, tetrapotassium polyphosphate, calcium orthophosphate, superphosphate, triple superphosphate, phosphate fertilizer, phosphate rock, bone phosphate, fishbone apatite, monocalcium phosphate, monoammonia phosphate, diammonium phosphate, dicalcium phosphate, tricalcium phosphate, trisodium phosphate, salts of phosphoric acid, pulverized phosphate rock, dolomitic limestone, hydrated limestone, calcium oxide, calcium carbonate, magnesium oxide, sodium metasilicate, potassium silicate, phosphorite, herring meal, bone meal and combinations thereof.

3. The method of claim 2, wherein the salts of phosphoric acid are alkali metal salts.

4. The method of claim 2, wherein the phosphate is a trisodium phosphate, dicalcium phosphate, disodium hydrogen phosphate, sodium dihydrogen phosphate, tripotassium phosphate, dipotassium hydrogen phosphate, potassium dihydrogen phosphate, trilithium phosphate, dilithium hydrogen phosphate, lithium dihydrogen phosphate or mixtures thereof.

5. The method of claim 2, wherein the phosphate and lead mineral complexing agent as iron, calcium, chloride, or aluminum are supplied as one product including triple superphosphate and combination fertilizer wet process mixtures.

6. The method of claim 2, wherein the lead mineral complexing agent is selected from the group consisting of calcium, silicates, sodium silicate, lime, magnesium oxides, calcium chloride, sodium chloride, potassium chloride, vanadium, boron, iron, surfactant, aluminum, sulfates, ferric sulfate, and combinations thereof.

7. The method of claim 1, wherein the phosphate is dicalcium phosphate in the presence of calcium chloride.

8. The method of claim 1, wherein the phosphate is amber phosphoric acid.

9. The method of claim 1, wherein the phosphate is green phosphoric acid.

10. The method of claim 1, wherein the phosphate is fishbone apatite.

11. The method of claim 1, wherein the phosphate is a slurry of dicalcium phosphates.

12. The method of claim 1, wherein the phosphate is tricalcium phosphate.

13. The method of claim 1, wherein the phosphate is pulverized triple superphosphate.

14. A method of reducing the leaching of lead from the surface of a lead projectile, comprising contacting lead projectile surface with at least one lead stabilizing agent and optionally a lead mineral complexing agent, in an amount effective in reducing the leaching of lead from lead projectile surface under natural or induced lead leaching conditions.

15. A method of reducing the leaching of lead from the surface of a lead projectile, comprising contacting lead projectile surface with at least one lead stabilizing agent and optionally a lead mineral complexing agent, in an amount effective in reducing the leaching of lead from lead projectile surface, to a level of 50 ppb as determined by Simulated Precipitant Leaching Procedure method 1310 or water leach test.

16. A method of reducing bioavailability of lead by reducing Pb solubility from the surface of a lead-containing projectile, comprising contacting lead projectile surface with at least one lead stabilizing agent and optionally a lead mineral complexing agent, in an amount effective in reducing the leaching of lead from lead projectile surface under natural or induced lead leaching conditions.

17. A lead-containing projectile having coated thereon at least one lead stabilizing agent and optionally a lead mineral complexing agent, in an amount effective in reducing the leaching of lead from lead projectile surface under natural or induced lead leaching conditions, whereby the lead and stabilizing agent form a mineral coating on the projectile in which the lead is in a form that is less soluble than its uncoated counterpart.

18. The lead-containing projectile of claim 17 wherein the projectile is in the form of pellets or shot and the stabilizing agent is dicalcium phosphate, tricalcium phosphate or combination thereof.

19. A method of producing a lead-containing projectile having a mineral coating thereon, comprising:
coating lead-containing projectile with at least one lead stabilizing agent and optionally a lead mineral complexing agent, in an amount effective in reducing the leaching of lead from lead projectile surface under natural or induced lead leaching conditions; and
allowing the coating to cure,
wherein the lead and stabilizing agent form a mineral coating on the projectile in which the lead is in a form that is less soluble than its uncoated projectile counterpart.
